(19) United States
(12) Patent Application Publication
(10) Pub. No.: US 2011/0316781 A1
(43) Pub. Date: Dec. 29, 2011

(54) MULTI-FUNCTIONAL MOUSE

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/878,218

(22) Filed: Sep. 9, 2010

(30) Foreign Application Priority Data
Jun. 29, 2010 (CN) 201020241409.X

(51) Int. Cl. G09G 5/08

(52) U.S. Cl. 345/163

(57) ABSTRACT

A multi-functional mouse transmits to an electronic device over radio. The multi-functional mouse comprises a power source, supplies power for the multi-functional mouse, a navigation module controlling the coordinates of a cursor on a screen of the electronic device, a card reader module using for reading data in a functional card connecting to the card reader, a USB module used to couple with peripheral devices, and a wireless transceiver module. The mouse electronically communicates with the electronic device.

### CROSS-REFERENCE TO RELATED APPLICATIONS

This application is related to co-pending U.S. Patent Applications (Attorney Docket No. U.S. Pat. No. 33,681, AND U.S. Pat. No. 33,683), all entitled “MULTI-FUNCTIONAL MOUSE”, by Wu et al. These applications have the same assignee as the present application and have been concurrently filed herewith. The above-identified applications are incorporated herein by reference.

### BACKGROUND

1. Technical Field

This disclosure relates to multi-functional mice.

2. Description of Related Art

Modern desktop computers provide users with user-input mechanisms that are well suited for the applications that run on these computers. For example, the desktop computers often use an external peripheral devices, such as a mouse, that allows the user to conveniently navigate through menus of an application, as well as allowing navigation between applications and selection of various choices with a “click and drag” option. However, most typical mice have only a navigation function.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary multi-functional mouse for electronic device. Moreover, in the drawings like reference numerals designate corresponding parts throughout the several views. Wherever possible, the same reference numbers are used throughout the drawings to refer to the same or like elements of an embodiment.

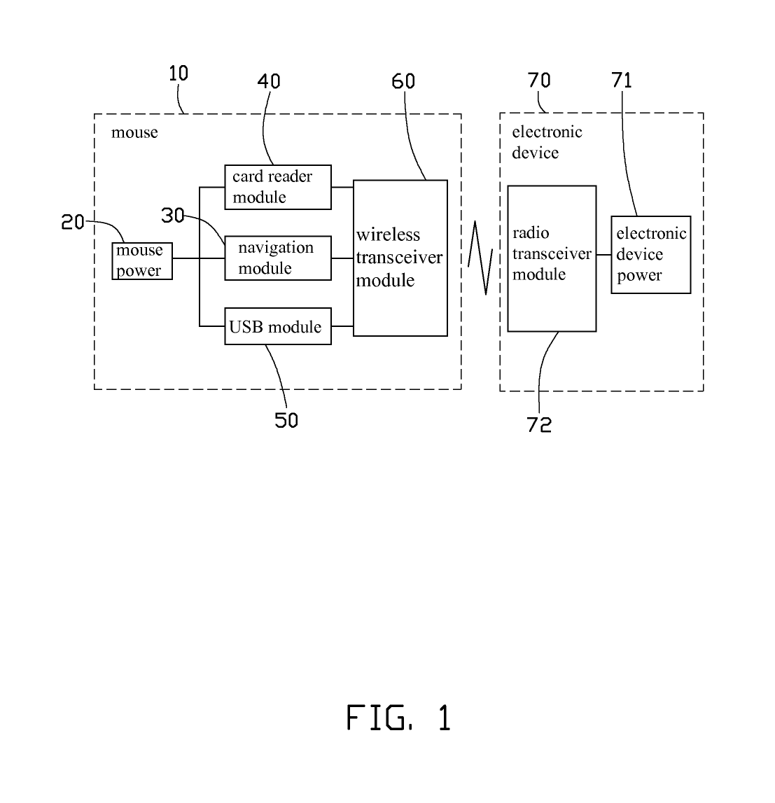

The FIG. 1 is a block diagram of an exemplary embodiment of a multi-functional mouse.

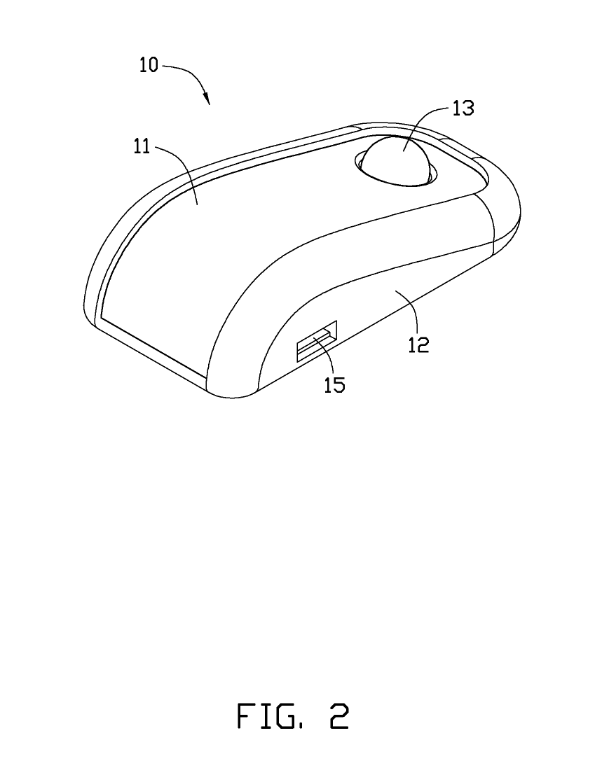

The FIG. 2 is a schematic view of the multi-functional mouse shown in FIG. 1.

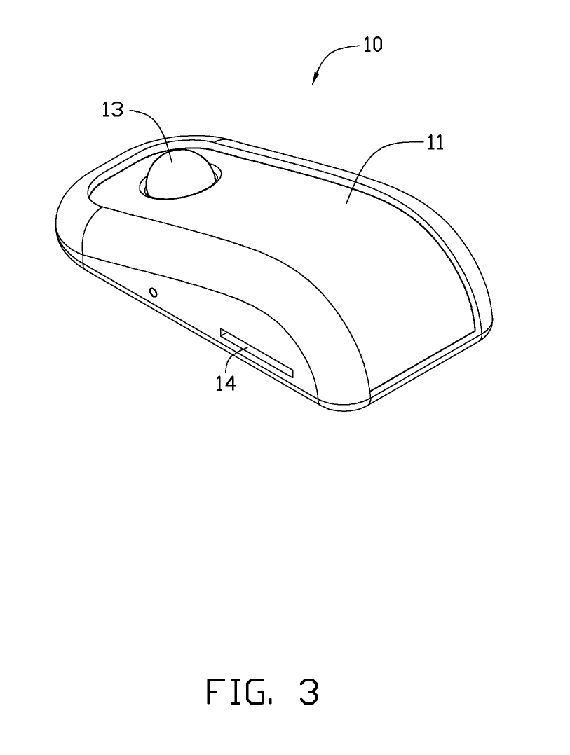

The FIG. 3 is a schematic view of the multi-functional mouse in FIG. 2 shown in another aspect.

### DETAILED DESCRIPTION

An exemplary multi-functional mouse 10 is illustrated in the FIGS. 1-3. The mouse 10 may transmit to an electronic device 70 (e.g., computer) either by hard-wire or wireless means. The mouse 10 includes an upper housing 11, a lower housing 12 mounted to the upper housing 11, a ball 13 rotatably mounted on the upper housing 11, a first interface 14 and a second interface 15 which are both mounted on the lower housing 12; a power source 20, a navigation module 30, a card reader module 40, a USB module 50, and in the present exemplary embodiment, a wireless transceiver module 60. The power source 20 supplies power for the mouse 10. The navigation module 30, the USB module 50 and the card reader module 40 electronically connect to the wireless transceiver module 60 to receive signals from and transmit signals to the electronic device 70. In this exemplary embodiment, the first interface 14 is an opening provided therein with attachment means to receive and electronically connect to a functional card such as Smart Media card (SMC), Compact Flash card (CFC), Secure Digital Memory Card (SDMC), or Trans Flash card (TFC). The second interface 15 is an opening provided therein with attachment means to receive and electronically connect to a USB connector. The electronic device 70 includes an electronic device power source 71 and a radio transceiver module 72. The electronic device power source 71 supplies power for the radio transceiver module 72.

The power source 20, respectively and electrically, connects to and supplies power for the navigation module 30, the card reader module 40 and the USB module 50. The power source 20 can be a rechargeable battery or a detachable battery pack so that the power source 20 can be recharged or replaced by a new power supply when the power source 20 is exhausted.

The wireless transceiver module 60, respectively and electronically, connects to the navigation module 30, the card reader module 40 and the USB module 50. The navigation module 30 controls the coordinates of a cursor on a screen of the electronic device 70 as the mouse 10 moves around on a mouse pad. The card reader module 40 electronically connects to the first interface 14 so that the card reader module 40 could read data in the functional card connected to the first interface 14. The USB module 50 is used to couple with peripheral devices, such as a an external memory source (flash or hard disk). The wireless transceiver module 60 may be BLUETOOTH RF technology or 2.4 Ghz radio frequency technology for implementing wireless communication.

To use the navigation module 30, the power source 20 supplies power to the navigation module 30. The navigation module 30 generates and sends indicating signals to the wireless transceiver module 60. Then the wireless transceiver module 60 transmits the indicating signals from the navigation module 30 to the radio transceiver module 72 to control the coordinates of the cursor on the screen.

To use the card reader module 40, the power source 20 supplies power to the card reader module 40. The card reader module 40 accommodates a functional card and generates a signal responding to the function card, to the wireless transceiver module 60. And then the wireless transceiver module 60 transmits the signal from the card reader module 40 to the radio transceiver module 72, to control the electronic device 70.

To use the USB module 50, the power source 20 supplies power to the USB module 50. The USB module 50 connects to a peripheral device (e.g., an external memory source (flash or hard disk)) and generates a signal responding to the peripheral device, to the wireless transceiver module 60. And then the wireless transceiver module 60 transmits the signal from the USB module 50 to the radio transceiver module 72, to transceiver data between the peripheral device and the electronic device 70.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A multi-functional mouse communicating with an electronic device, comprising:
a power source supplies power for the multi-functional mouse;
a navigation module controlling the coordinates of a cursor on a screen of the electronic device;
a card reader module using for reading data in a functional card connecting to the card reader;
a USB module used to couple with peripheral devices; and
the mouse electronically communicating with the electronic device.

2. The multi-functional mouse as claimed in claim 1, wherein the mouse electronically communicates to the electronic device using a wireless transceiver module communicating with the electronic device via wireless communication technology; the wireless transceiver module, respectively and electrically, connecting to the navigation module, the USB module and the card reader module.

3. The multi-functional mouse as claimed in claim 2, wherein the power source, respectively and electrically, connects to the navigation module, the card reader module and the USB module.

4. The multi-functional mouse as claimed in claim 2, wherein the power source is rechargeable.

5. The multi-functional mouse as claimed in claim 2, wherein the wireless transceiver module is Bluetooth or 2.4 G radio frequency.

6. The multi-functional mouse as claimed in claim 2, wherein the functional mouse includes an upper housing and a lower housing mounted to the upper housing; the lower housing defines a first interface for accommodating the card reader module and a second interface or accommodating the USB module.
